(19) United States
(12) Patent Application Publication
(10) Pub. No.: US 2019/0368738 A1
(43) Pub. Date: Dec. 5, 2019

(54) METHOD AND SYSTEM FOR AERO-SHAPED LIQUID FUEL POSTS FOR MICROMIXERS

(71) Applicant: General Electric Company, Schenectady, NY (US)

(72) Inventors: Owen James Sullivan Rickey, Saratoga Springs, NY (US); Joel Meier Haynes, Niskayuna, NY (US); Shih-Yang Hsieh, Cohoes, NY (US); Su Cao, Schenectady, NY (US); Seung-Hyuck Hong, Clifton Park, NY (US)

(21) Appl. No.: 15/995,955

(22) Filed: Jun. 1, 2018

(51) Int. Cl. F23R 3/28; F02C 7/22; B33Y 80/00; B01F 13/00; B01F 3/04

(52) U.S. Cl. CPC F23R 3/28; F02C 7/22; B33Y 80/00; B33Y 10/00; B01F 3/04049; F05D 2240/36; B01F 13/0064

(57) ABSTRACT

A liquid fuel injection assembly for a gas turbine engine is provided. The liquid fuel injection assembly includes at least one micromixer, at least one liquid fuel injection nozzle, and at least one post. The at least one micromixer includes at least one wall defining a conduit. The at least one liquid fuel injection nozzle extends from the at least one wall into the conduit. The at least one liquid fuel injection nozzle has a first drag coefficient. The at least one liquid fuel injection nozzle is configured to inject a flow of liquid fuel into the flow of air. The at least one post extends from the at least one wall and circumscribes the at least one liquid fuel injection nozzle. The liquid fuel injection nozzle and post have a second drag coefficient. The first drag coefficient is greater than the second drag coefficient.

### BACKGROUND

The field of the present disclosure relates generally to turbine engines and, more specifically, to a liquid fuel injection post for use in a turbine engine.

Rotary machines, such as gas turbines, are often used to generate power for electric generators. Gas turbines, for example, have a gas path which typically includes, in serial-flow relationship, an air intake, a compressor, a combustor, a turbine, and a gas outlet. At least some known turbine engines have high specific work and power per unit mass flow requirements. To increase power output and operating efficiency, at least some known gas turbine engines use a liquid fuel (e.g., liquid hydrocarbons such as gasoline) rather than vapor fuel (e.g., natural gas).

The liquid fuel must be thoroughly mixed with combustion air in order to efficiently combust the liquid fuel. At least some known gas turbines mix natural gas with combustion air in a micromixer. The micromixer includes a tube with a plurality of perforations through which natural gas is introduced into the combustion air stream. The end of the perforations, or the injection points, are generally flush with the wall of the micromixer. The natural gas is able to mix with the combustion air because the natural gas is a vapor. However, liquid fuel introduced through the same perforations may not entrain with the combustion gas because the perforations do not introduce the liquid fuel far enough into the micromixer.

### BRIEF DESCRIPTION

In one aspect, a liquid fuel injection assembly for a gas turbine engine is provided. The liquid fuel injection assembly includes at least one micromixer, at least one liquid fuel injection nozzle, and at least one post. The at least one micromixer includes at least one wall defining a conduit configured to channel a flow of air. The at least one liquid fuel injection nozzle extends from the at least one wall into the conduit. The at least one liquid fuel injection nozzle has a first drag coefficient. The at least one liquid fuel injection nozzle is configured to inject a flow of liquid fuel into the flow of air. The at least one post extends from the at least one wall and circumscribes the at least one liquid fuel injection nozzle. The at least one liquid fuel injection nozzle and the at least one post have a second drag coefficient. The first drag coefficient is greater than the second drag coefficient.

In another aspect, a liquid fuel injection assembly for a gas turbine engine is provided. The gas turbine engine includes a compressor and a combustor. The liquid fuel injection assembly includes at least one micromixer and at least one liquid fuel injection nozzle. The at least one micromixer includes at least one wall defining a conduit configured to channel a flow of air from the compressor to the combustor. The at least one liquid fuel injection nozzle extending from the at least one wall into the conduit. The at least one liquid fuel injection nozzle is configured to inject a flow of liquid fuel into the flow of air and the conduit is configured to channel the flow of air and the flow of liquid fuel into the combustor.

In yet another aspect, a method of manufacturing a liquid fuel injection assembly for a gas turbine is provided. The method includes providing a micromixer including at least one wall defining a conduit. The conduit is configured to channel a flow of air. The method also includes forming at least one liquid fuel injection nozzle extending into the conduit. The at least one liquid fuel injection nozzle is configured to inject a flow of liquid fuel into the flow of air. The at least one liquid fuel injection nozzle has a first drag coefficient. The method further includes forming at least one post extending from the at least one wall and circumscribing the at least one liquid fuel injection nozzle. The at least one liquid fuel injection nozzle and the at least one post have a second drag coefficient. The first drag coefficient is greater than the second drag coefficient.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an exemplary turbine engine;

FIG. 2 is a sectional view of an exemplary micromixer that may be used with the turbine engine shown in FIG. 1 with an injection nozzle extending into the micromixer;

FIG. 3 is a sectional view of an exemplary micromixer that may be used with the turbine engine shown in FIG. 1 with an injection nozzle extending into the micromixer;

FIG. 4 is a sectional view of an exemplary micromixer that may be used with the turbine engine shown in FIG. 1 with a reduced thickness liquid fuel injection nozzle extending into the micromixer;

FIG. 5 is a sectional view of an exemplary micromixer that may be used with the turbine engine shown in FIG. 1 with an angled, reduced thickness liquid fuel injection nozzle extending into the micromixer;

FIG. 6 is a schematic cutaway view of an exemplary micromixer that may be used with the turbine engine shown in FIG. 1 with a post circumscribing an injection nozzle;

FIG. 7 is a schematic cutaway view of an exemplary micromixer that may be used with the turbine engine shown in FIG. 1 with a post circumscribing an injection nozzle;

FIG. 8 is a schematic cutaway view of an exemplary micromixer that may be used with the turbine engine shown in FIG. 1 showing a top view of the post shown in FIG. 7;

FIG. 9 is a schematic cutaway view of an exemplary micromixer that may be used with the turbine engine shown in FIG. 1 showing a front view of the post shown in FIG. 7;

FIG. 10 is a schematic cutaway view of an exemplary micromixer that may be used with the turbine engine shown in FIG. 1 showing a back view of post the post shown in FIG. 7;

FIG. 11 is a schematic cutaway view of an exemplary micromixer that may be used with the turbine engine shown in FIG. 1 with a post circumscribing an injection nozzle;

FIG. 12 is a schematic cutaway view of an exemplary micromixer that may be used with the turbine engine shown in FIG. 1 with a post circumscribing an injection nozzle;

FIG. 13 is a schematic cutaway view of an exemplary micromixer that may be used with the turbine engine shown in FIG. 1 with a post circumscribing an injection nozzle;

FIG. 14 is a schematic cutaway view of an exemplary micromixer that may be used with the turbine engine shown in FIG. 1 with a post circumscribing an injection nozzle;

FIG. 15 is a schematic cutaway view of an exemplary micromixer that may be used with the turbine engine shown in FIG. 1 with a post circumscribing an injection nozzle;

FIG. 16 is a schematic cutaway view of an exemplary micromixer that may be used with the turbine engine shown in FIG. 1 showing a top view of post the post shown in FIG. 15;

FIG. 17 is a schematic cutaway view of an exemplary micromixer that may be used with the turbine engine shown in FIG. 1 with a post circumscribing an injection nozzle;

FIG. 18 is a schematic cutaway view of an exemplary micromixer that may be used with the turbine engine shown in FIG. 1 with a post circumscribing an injection nozzle;

FIG. 19 is a schematic cutaway view of an exemplary micromixer that may be used with the turbine engine shown in FIG. 1 showing a back view of post the post shown in FIG. 18; and

FIG. 20 is a flow diagram of a method of manufacturing a liquid fuel injection assembly for the gas turbine engine shown in FIG. 1.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, a programmable logic controller (PLC), and application specific integrated circuit, and other programmable circuits, and these terms are used interchangeably herein. In the embodiments described herein, memory may include, but it not limited to, a computer-readable medium, such as a random access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program storage in memory for execution by personal computers, workstations, clients, and servers.

As used herein, the term “non-transitory computer-readable media” is intended to be representative of any tangible computer-based device implemented in any method of technology for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including without limitation, volatile and non-volatile media, and removable and non-removable media such as firmware, physical and virtual storage, CD-ROMS, DVDs, and any other digital source such as a network or the Internet, as well as yet to be developed digital means, with the sole exception being transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

Additive manufacturing processes and systems include, for example, and without limitation, vat photopolymerization, powder bed fusion, binder jetting, material jetting, sheet lamination, material extrusion, directed energy deposition and hybrid systems. These processes and systems include, for example, and without limitation, SLA—Stereolithography Apparatus, DLP—Digital Light Processing, 3 SP—Scan, Spin, and Selectively Photocure, CLIP—Continuous Liquid Interface Production, SLS—Selective Laser Sintering, DMLS—Direct Metal Laser Sintering, SLM—Selective Laser Melting, EBM—Electron Beam Melting, SHS—Selective Heat Sintering, MJF—Multi-Jet Fusion, 3D Printing, Voxeljet, Polyjet, SCP—Smooth Curvatures Printing, MJM—Multi-Jet Modeling Projet, LOM—Laminated Object Manufacture, SDL—Selective Deposition Lamination, UAM—Ultrasonic Additive Manufacturing, FFF—Fused Filament Fabrication, FDM—Fused Deposition Modeling, LIVID—Laser Metal Deposition, LENS—Laser Engineered Net Shaping, DMD—Direct Metal Deposition, Hybrid Systems, and combinations of these processes and systems. These processes and systems may employ, for example, and without limitation, all forms of electromagnetic radiation, heating, sintering, melting, curing, binding, consolidating, pressing, embedding, and combinations thereof.

Additive manufacturing processes and systems employ materials including, for example, and without limitation, polymers, plastics, metals, ceramics, sand, glass, waxes, fibers, biological matter, composites, and hybrids of these materials. These materials may be used in these processes and systems in a variety of forms as appropriate for a given material and the process or system, including, for example, and without limitation, as liquids, solids, powders, sheets, foils, tapes, filaments, pellets, liquids, slurries, wires, atomized, pastes, and combinations of these forms.

Embodiments of liquid fuel injection nozzles and liquid fuel injection posts, as described herein, overcome a number of deficiencies of known liquid fuel injection system for gas turbine engines. Specifically, the liquid fuel injection nozzles described herein increase entrainment of liquid fuel into compressed air by injecting a flow of fuel into the center of a micromixer. Increasing the entrainment of fuel into compressed air reduces coking downstream of the liquid fuel injection nozzle, allows for an even and center-biased fuel distribution, and increases the efficiency of the gas turbine engine. Additionally, liquid fuel injection posts circumscribe the liquid fuel injection nozzles and increase the flow of compressed air towards the liquid fuel injection nozzles, further increasing the entrainment of fuel within the flow of compressed air. Additionally, the liquid fuel injection posts increase the efficiency of the gas turbine engine by reducing the drag coefficient of the liquid fuel injection nozzles and liquid fuel injection posts within the micromixer.

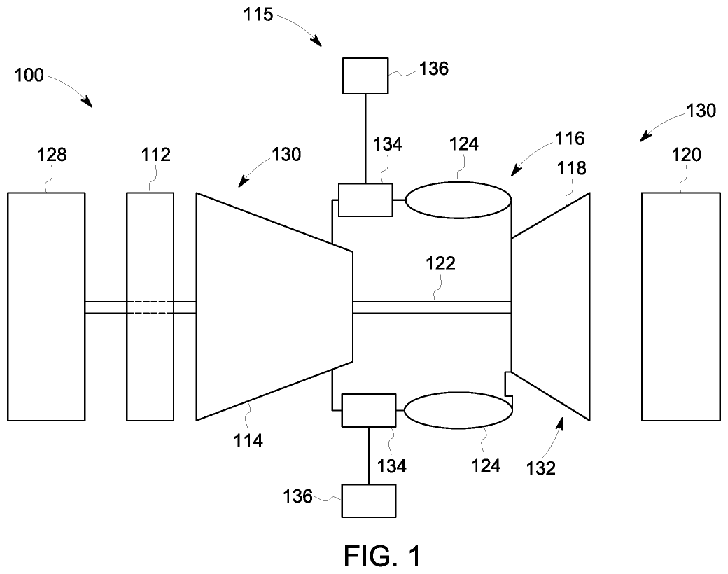

FIG. 1 is a schematic view of an exemplary turbine engine 100. More specifically, in the exemplary embodiment turbine engine 100 is a gas turbine engine that includes an intake section 112, a compressor section 114 downstream from intake section 112, a combustor section 116 downstream from compressor section 114, a turbine section 118 downstream from combustor section 116, and an exhaust section 120. Turbine section 118 is coupled to compressor section 114 via a rotor shaft 122. In the exemplary embodiment, combustor section 116 includes a plurality of combustors 124. Combustor section 116 is coupled to compressor section 114 such that each combustor 124 is in flow communication with compressor section 114. In the exemplary embodiment, a liquid fuel injection assembly 115 is configured to inject fuel into a flow of compressed air from compressor section 114. In the exemplary embodiment, liquid fuel injection assembly 115 includes a plurality of micromixers 134 configured to channel compressed air from compressor section 114 to combustor section 116. Liquid fuel injection assembly 115 also includes at least one fuel supply system 136 coupled in flow communication with micromixers 134. Fuel supply system 136 is configured to channel fuel to micromixers 136 where the flow of fuel is injected into a flow of compressed air. Turbine section 118 is coupled to compressor section 114 and to a load 128 such as, but not limited to, an electrical generator and/or a mechanical drive application through rotor shaft 122. In the exemplary embodiment, each of compressor section 114 and turbine section 118 includes at least one rotor disk assembly 130 that is coupled to rotor shaft 122 to form a rotor assembly 132.

During operation, intake section 112 channels air towards compressor section 114 wherein the air is compressed to a higher pressure and temperature prior to being discharged towards combustor section 116. The compressed air is channeled through micromixers 134 where a flow of fuel is injected into the compressed air. The mixture of fuel and compressed air is then ignited in combustor section 116 to generate combustion gases that are channeled towards turbine section 118. More specifically, the fuel mixture is ignited to generate high temperature combustion gases that are channeled towards turbine section 118. Turbine section 118 converts the energy from the gas stream to mechanical rotational energy, as the combustion gases impart rotational energy to turbine section 118 and to rotor assembly 132.

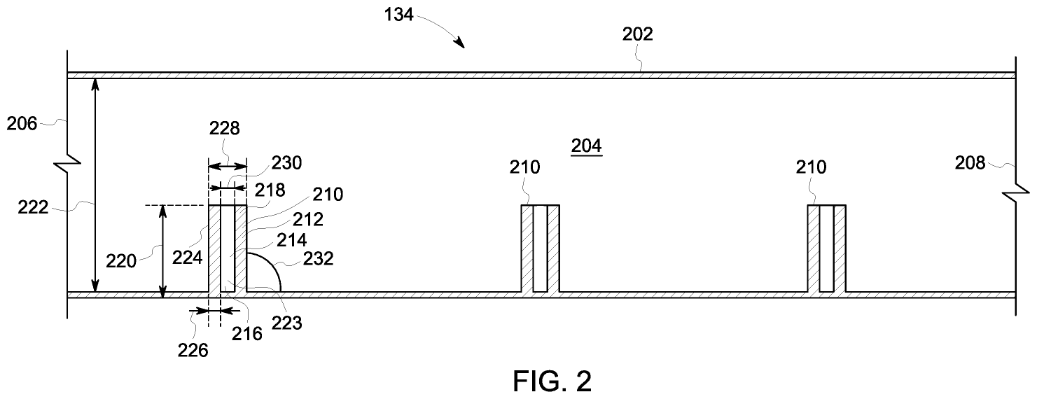

FIG. 2 is a schematic cutaway view of an exemplary micromixer 134. In the exemplary embodiment, micromixer 134 includes at least one first wall 202 defining a first conduit 204. First conduit 204 includes a first end 206 and a second end 208 and is configured to channel a flow of compressed air from first end 206 to second end 208. In the exemplary embodiment, micromixer 134 includes a single circular first wall 202 such that micromixer 134 has a tubular or cylindrical shape. In alternative embodiments, micromixer 134 may include any number of first walls 202 and any shape that enables turbine engine 100 to operate as described herein. In the exemplary embodiment, first end 206 is coupled in flow communication with compressor section 114 and second end 208 is couple in flow communication with combustor section 116.

In the exemplary embodiment, micromixer 134 includes at least one liquid fuel injection nozzle 210 extending into first conduit 204. In the exemplary embodiment, each liquid fuel injection nozzle 210 includes at least one second wall 212 defining a second conduit 214. Second conduit 214 includes a first end 216 and a second end 218 and is configured to channel a flow of fuel from first end 216 to second end 218. In the exemplary embodiment, liquid fuel injection nozzle 210 includes a single circular second wall 212 such that liquid fuel injection nozzle 210 has a tubular or cylindrical shape. In alternative embodiments, liquid fuel injection nozzle 210 may include any number of second walls 212 and any shape that enables turbine engine 100 to operate as described herein. In the exemplary embodiment, first end 216 is coupled in flow communication with first conduit 204 and second end 218 is couple in flow communication with fuel supply system 136. In the exemplary embodiment, micromixer 134 includes three liquid fuel injection nozzles 210. In alternative embodiments, micromixer 134 may include any number of liquid fuel injection nozzles 210 that enables turbine engine 100 to operate as described herein, including a plurality of liquid fuel injection nozzles 210.

In the exemplary embodiment, liquid fuel injection nozzle 210 extends a distance 220 into conduit 204 and micromixer 134 has a first diameter 222. In the exemplary embodiment, first diameter 222 is about 0.25″ to about 1.5″ and distance 220 is about 0.05″ to about 1.2″ such that distance 220 is about 20% to about 80% of first diameter 222. Second wall 212 includes an inner surface 223, an outer surface 224, and a thickness 226 extending therebetween. In the exemplary embodiment, outer surface 224 defines an outer diameter 228 and inner surface 223 defines an inner diameter 230. In the exemplary embodiment, liquid fuel injection nozzle 210 and first wall 202 define an angle 232 therebetween. In the exemplary embodiment, angle 232 is about 90 degrees such that liquid fuel injection nozzle 210 is oriented substantially perpendicular to first wall 202. In alternative embodiments, angle 232 includes any angle that enables turbine engine 100 to operate as described herein. In the exemplary embodiment, liquid fuel injection nozzle 210 extends into conduit 204 such that liquid fuel injection nozzle 210 has a first drag coefficient. As used herein, a drag coefficient is a dimensionless number that quantifies the resistance to the flow of compressed air through conduit 204 caused by liquid fuel injection nozzle 210 extending into conduit 204 and the flow path of the flow of compressed air.

In the exemplary embodiment, fuel supply system 136 channels a flow of fuel to liquid fuel injection nozzle 210 which, in turn, channels the flow of liquid fuel into conduit 204. As such, liquid fuel injection nozzle 210 injects the flow of liquid fuel into the flow of compressed air within conduit 204. Because liquid fuel injection nozzle 210 extends into conduit 204, liquid fuel injection nozzle 210 causes turbulence within the flow of compressed air. This turbulence increases the entrainment of the flow of liquid fuel within the flow of compressed air. Additionally, injecting the flow of fuel into the flow of compressed air close to the center of micromixer 134, rather than at first wall 202, increases the entrainment of the flow of liquid fuel within the flow of compressed air. This arrangement reduces coking downstream of liquid fuel injection nozzle 210 and also allows for an even and center-biased fuel distribution. Additionally, liquid fuel injection nozzle 210 could be combined with a plurality of gas fuel injection nozzles (not shown) to allow micromixer 134 to be a dual-fuel micromixer.

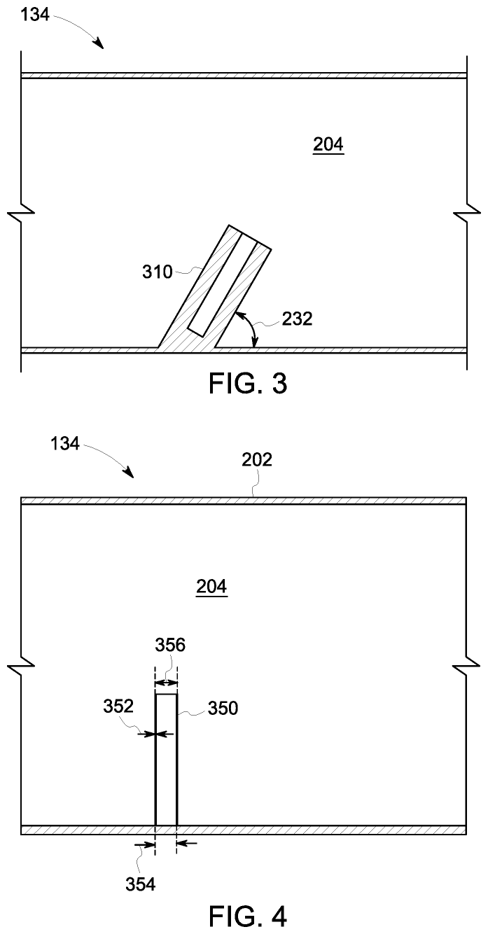

FIG. 3 is a schematic cutaway view of an exemplary micromixer 134 with an angled liquid fuel injection nozzle 310. In the exemplary embodiment, angle 232 of angled liquid fuel injection nozzle 310 is less than 90 degrees and greater than 30 degrees. Specifically, angle 232 of angled liquid fuel injection nozzle 310 is about 60 degrees such that liquid fuel injection nozzle 210 is oriented obliquely relative to first wall 202. In alternative embodiments, angle 232 is about 30 degrees to about 90 degrees. The angled configuration of angled liquid fuel injection nozzle 310 improves entrainment of liquid fuel within the flow of compressed air because the wake caused by angled liquid fuel injection nozzle 310 dissipates a shorter distance downstream of angled liquid fuel injection nozzle 310 than the wake caused by liquid fuel injection nozzle 210. Additionally, dissipation of the wake closer to angled liquid fuel injection nozzle 310 may prevent fuel entrainment on a downstream portion of angled liquid fuel injection nozzle 310.

FIG. 4 is a schematic cutaway view of an exemplary micromixer 134 with a reduced thickness liquid fuel injection nozzle 350. In the exemplary embodiment, reduced thickness liquid fuel injection nozzle 350 is substantially similar to liquid fuel injection nozzle 210 except that reduced thickness liquid fuel injection nozzle 350 includes a reduced thickness 352, a reduced inner diameter 354, and a reduced outer diameter 356. In the exemplary embodiment, reduced thickness 352 is about 0.001 inches to about 0.01 inches. More particularly, reduced thickness 352 is about 0.005 inches. In the exemplary embodiment, reduced inner diameter 354 is about 0.01 inches to about 0.03 inches. More particularly, reduced inner diameter 354 is about 0.02 inches. In the exemplary embodiment, reduced outer diameter 356 is about 0.012 inches to about 0.05 inches. More particularly, reduced outer diameter 356 is about 0.03 inches. Reduced outer diameter 356 reduces the profile of reduced thickness liquid fuel injection nozzle 350 relative to the flow of compressed air within conduit 204, and, as such, reduces a drag coefficient of reduced thickness liquid fuel injection nozzle 350 within conduit 204.

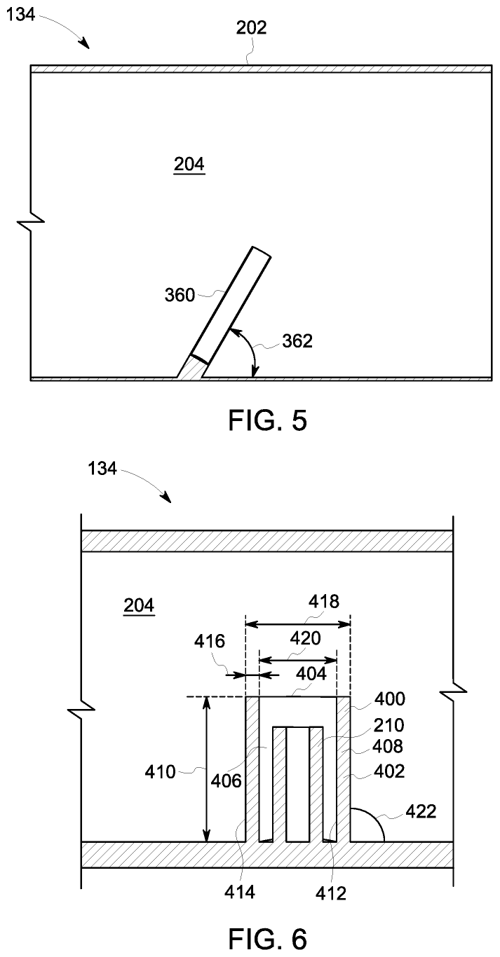

FIG. 5 is a schematic cutaway view of an exemplary micromixer 134 with an angled, reduced thickness liquid fuel injection nozzle 360. In the exemplary embodiment, an angle 362 of angled, reduced thickness liquid fuel injection nozzle 360 is about 45 degrees such that angled, reduced thickness liquid fuel injection nozzle 360 is oriented obliquely relative to first wall 202. In alternative embodiments, angle 362 is about 30 degrees to about 90 degrees. The angled configuration of angled, reduced thickness liquid fuel injection nozzle 360 improves entrainment of liquid fuel within the flow of compressed air because the wake caused by angled, reduced thickness liquid fuel injection nozzle 360 dissipates a shorter distance downstream of angled, reduced thickness liquid fuel injection nozzle 360 than the wake caused by reduced thickness liquid fuel injection nozzle 350. Additionally, dissipation of the wake closer to angled, reduced thickness liquid fuel injection nozzle 360 may prevent fuel entrainment on a downstream portion of angled, reduced thickness liquid fuel injection nozzle 360.

FIG. 6 is a schematic cutaway view of an exemplary micromixer 134 with a post 400 circumscribing liquid fuel injection nozzle 210. In the exemplary embodiment, post 400 circumscribes liquid fuel injection nozzle 210 and is configured to reduce the drag coefficient of liquid fuel injection nozzle 210 within conduit 204. Post 400 includes a body 402 defining an opening 404 and a chamber 406. In the exemplary embodiment, body 402 includes at least one third wall 408 defining opening 404 and chamber 406. In the exemplary embodiment, post 400 includes a single circular third wall 408 such that post 400 has a tubular or cylindrical shape. In alternative embodiments, post 400 may include any number of third walls 408 and any shape that enables turbine engine 100 to operate as described herein.

In the exemplary embodiment, post 400 extends a distance 410 into conduit 204. In the exemplary embodiment, distance 410 is about 0.05″ to about 1.2″ such that distance 410 is about 20% to about 80% of first diameter 222. Distance 410 is longer than distance 220 such that post 400 extends into conduit 204 farther than liquid fuel injection nozzle 210 extends into conduit 204. Third wall 408 includes an inner surface 412, an outer surface 414, and a thickness 416 extending therebetween. In the exemplary embodiment, inner surface 412 defines chamber 406. In the exemplary embodiment, outer surface 414 defines an outer diameter 418 and inner surface 412 defines an inner diameter 420. In the exemplary embodiment, post 400 and first wall 202 define an angle 422 therebetween. Inner diameter 420 is larger than outer diameter 228 such that inner surface 412 circumscribes liquid fuel injection nozzle 210 and defines chamber 406. In the exemplary embodiment, angle 422 is about 90 degrees such that post 400 is oriented substantially perpendicular to first wall 202. In alternative embodiments, angle 422 includes any angle that enables turbine engine 100 to operate as described herein. In the exemplary embodiment, liquid fuel injection nozzle 210 and post 400 together have a second drag coefficient less than the first drag coefficient.

In the exemplary embodiment, fuel supply system 136 channels a flow of fuel to liquid fuel injection nozzle 210 which, in turn, channels the flow of liquid fuel into chamber 406. Chamber 406 then channels the flow of liquid fuel through opening 404 into conduit 204. As such, liquid fuel injection nozzle 210 and post 400 inject the flow of liquid fuel into the flow of compressed air within conduit 204. Because liquid fuel injection nozzle 210 and post 400 extend into conduit 204, liquid fuel injection nozzle 210 and post 400 cause turbulence within the flow of compressed air. This turbulence increases the entrainment of the flow of liquid fuel within the flow of compressed air. That is, liquid fuel injection nozzle 210 and post 400 channel a portion of the flow of compressed air around the flow of liquid fuel such that the flow of liquid fuel is entrained deeper further downstream of liquid fuel injection nozzle 210 and post 400. Additionally, injecting the flow of fuel into the flow of compressed air close to the center of micromixer 134, rather than at first wall 202, increases the entrainment of the flow of liquid fuel within the flow of compressed air. This arrangement reduces coking downstream of liquid fuel injection nozzle 210 and also allows for an even and center-biased fuel distribution. Additionally, post 400 creates additional turbulence patterns within conduit 204 that increase the flow of compressed air towards liquid fuel injection nozzle 210 and increases the entrainment of the flow of liquid fuel within the flow of compressed air. Because the second drag coefficient is less than the first drag coefficient, post 400 reduces the drag coefficient of liquid fuel injection nozzle 210 within micromixer 134 such that the efficiency of engine 100 is increased.

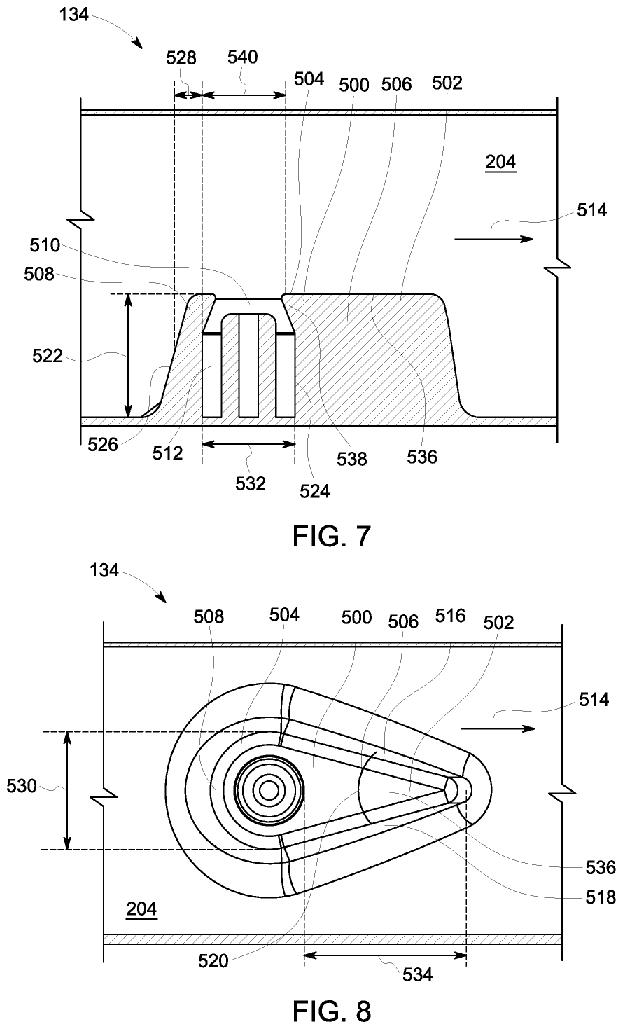

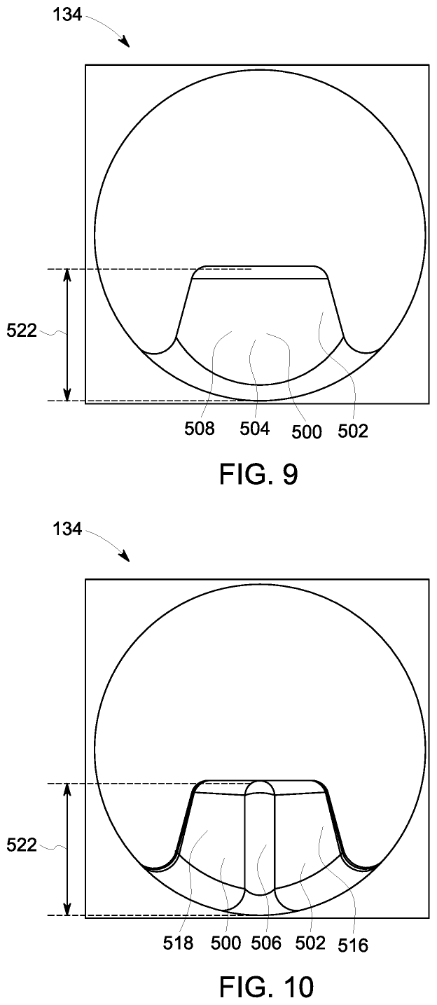

FIG. 7 is a schematic cutaway view of an exemplary micromixer 134 with a post 500 circumscribing liquid fuel injection nozzle 210. FIG. 8 is a schematic cutaway view of an exemplary micromixer 134 showing a top view of post 500 circumscribing liquid fuel injection nozzle 210. FIG. 9 is a schematic cutaway view of an exemplary micromixer 134 showing a front view (looking in the direction of flow through micromixer 134) of post 500 circumscribing liquid fuel injection nozzle 210. FIG. 10 is a schematic cutaway view of an exemplary micromixer 134 showing a back view (looking opposite the direction of flow through micromixer 134) of post 500 circumscribing liquid fuel injection nozzle 210. In the exemplary embodiment, post 500 circumscribes liquid fuel injection nozzle 210 and is configured to reduce the drag coefficient of liquid fuel injection nozzle 210 within conduit 204. Post 500 includes a body 502 including a proximal portion 504 and a distal portion 506. Proximal portion 504 includes at least one fourth wall 508 defining an opening 510 and a chamber 512. In the exemplary embodiment, post 500 includes a single generally circular fourth wall 508 such that proximal portion 504 has a generally tubular or cylindrical shape. In alternative embodiments, proximal portion 504 may include any number of fourth walls 508 and any shape that enables turbine engine 100 to operate as described herein. Distal portion 506 is coupled to proximal portion 504 and extends from proximal portion 504 in a direction of fluid flow 514 within conduit 204. In the exemplary embodiment, distal portion 506 includes a first side 516 and a second side 518 forming an angle 520 therebetween. First side 516, second side 518, and fourth wall 508 are coupled together such that distal portion 506 has a triangular prism shape. In the exemplary embodiment, proximal portion 504 and distal portion 506 are coupled together such that body 502 has a tear drop shape.

In the exemplary embodiment, post 500 extends a distance 522 into conduit 204. In the exemplary embodiment, distance 522 is about 0.05″ to about 1.2″ such that distance 522 is about 20% to about 80% of first diameter 222. Distance 522 is longer than distance 220 such that post 500 extends into conduit 204 farther than liquid fuel injection nozzle 210 extends into conduit 204. Fourth wall 508 includes an inner surface 524, an outer surface 526, and a thickness 528 extending therebetween. In the exemplary embodiment, inner surface 524 defines chamber 512. In the exemplary embodiment, outer surface 526 defines an outer diameter 530 and inner surface 524 defines an inner diameter 532. Inner diameter 532 is larger than outer diameter 228 such that inner surface 524 circumscribes liquid fuel injection nozzle 210. In the exemplary embodiment, angle 520 is about 30 degrees. In alternative embodiments, angle 520 is about 20 degrees to about 40 degrees. In alternative embodiments, angle 520 includes any angle that enables turbine engine 100 to operate as described herein.

In the exemplary embodiment, distal portion 506 extends a length 534 from proximal portion 504 in direction of fluid flow 514 within conduit 204. Distal portion 506 includes a top surface 536 extending substantially parallel to first wall 202. In the exemplary embodiment, fourth wall 508 includes an annular lip 538 extending into chamber 512 and defines an opening diameter 540. In the exemplary embodiment, opening diameter 540 is smaller than inner diameter 532 such that opening 510 is narrower than chamber 512. In the exemplary embodiment, liquid fuel injection nozzle 210 and post 500 have a third drag coefficient less than the first drag coefficient.

In the exemplary embodiment, fuel supply system 136 channels a flow of fuel to liquid fuel injection nozzle 210 which, in turn, channels the flow of liquid fuel into chamber 512. Chamber 512 then channels the flow of liquid fuel through opening 510 into conduit 204. As such, liquid fuel injection nozzle 210 and post 500 inject the flow of liquid fuel into the flow of compressed air within conduit 204. Because liquid fuel injection nozzle 210 and post 500 extend into conduit 204, liquid fuel injection nozzle 210 and post 500 cause turbulence within the flow of compressed air. This turbulence increases the entrainment of the flow of liquid fuel within the flow of compressed air. Additionally, injecting the flow of fuel into the flow of compressed air close to the center of micromixer 134, rather than at first wall 202, increases the entrainment of the flow of liquid fuel within the flow of compressed air. This arrangement reduces coking downstream of liquid fuel injection nozzle 210 and also allows for an even and center-biased fuel distribution. Additionally, post 500 creates additional turbulence patterns within conduit 204 that increase the flow of compressed air towards liquid fuel injection nozzle 210 and increase the entrainment of the flow of liquid fuel within the flow of compressed air. Additionally, because the third drag coefficient is less than the first drag coefficient, the aerodynamic shape of post 500 increases the efficiency of turbine engine 100 by reducing drag coefficient of liquid fuel injection nozzle 210 within micromixer 134. Furthermore, when micromixer 134 is a dual-fuel micromixer that injects liquid fuel as well as vapor fuel, liquid fuel injection nozzle 210 and post 500 are configured to prevent the vapor fuel from entrainment in the wake of liquid fuel injection nozzle 210 and post 500.

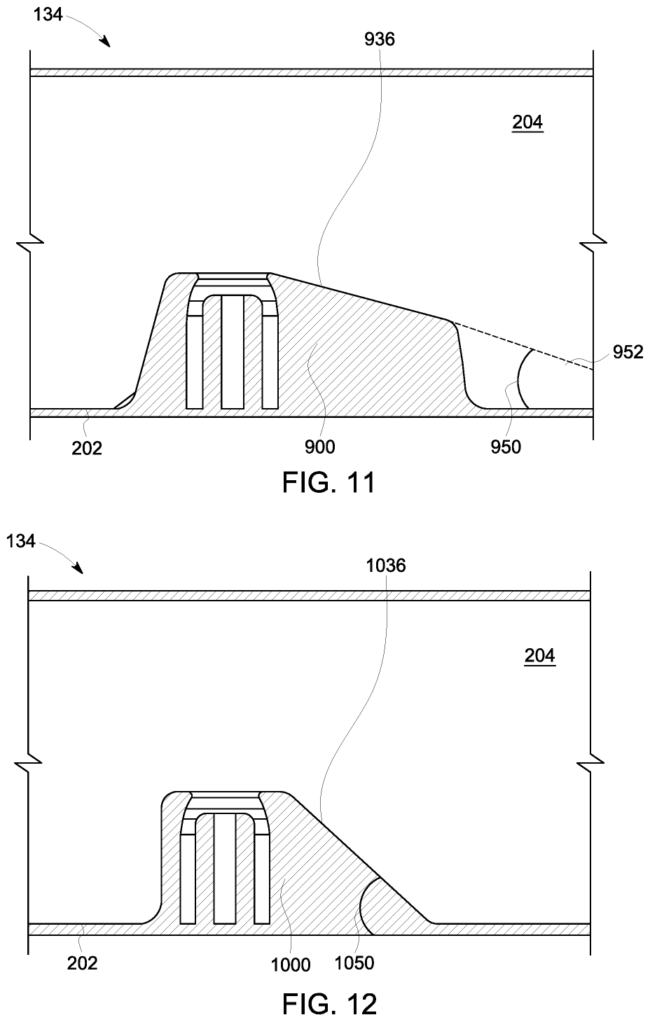

FIG. 11 is a schematic cutaway view of an exemplary micromixer 134 with a post 900 circumscribing liquid fuel injection nozzle 210. Post 900 is substantially similar to post 500 except that post 900 includes an angled top surface 936. In the exemplary embodiment, angled top surface 936 and first wall 202 form an angle 950. A dashed line 952 is a continuation of angled top surface 936. Angled top surface 936 creates a back draft that reduces drag within micromixer 134. In the exemplary embodiment, angle 950 is about 15 degrees. In alternative embodiments, angle 950 is about 0 degrees to about 25 degrees. In alternative embodiments, angle 950 includes any angle that enables turbine engine 100 to operate as described herein. Post 900 has an angled configuration such that angled top surface 936 is angled away from the combined flow of compressed air and liquid fuel as the liquid fuel expands into micromixer 134 so that the liquid fuel does not entrain on angled top surface 936. Additionally, angled top surface 936 reduces the wake caused by post 900 and liquid fuel injection nozzle 210.

FIG. 12 is a schematic cutaway view of an exemplary micromixer 134 with a post 1000 circumscribing liquid fuel injection nozzle 210. Post 1000 is substantially similar to post 500 except that post 1000 includes an angled top surface 1036 that intersects first wall 202. In the exemplary embodiment, angled top surface 1036 and first wall 202 form an angle 1050. Angled top surface 1036 creates a back draft that reduces drag within micromixer 134. In the exemplary embodiment, angle 1050 is about 40 degrees. In alternative embodiments, angle 1050 is about 15 degrees to about 60 degrees. In alternative embodiments, angle 1050 includes any angle that enables turbine engine 100 to operate as described herein. Post 1000 has an angled configuration such that angled top surface 1036 is angled away from the combined flow of compressed air and liquid fuel as the liquid fuel expands into micromixer 134 so that the liquid fuel does not entrain on angled top surface 1036. Additionally, angled top surface 1036 reduces the wake caused by post 1000 and liquid fuel injection nozzle 210.

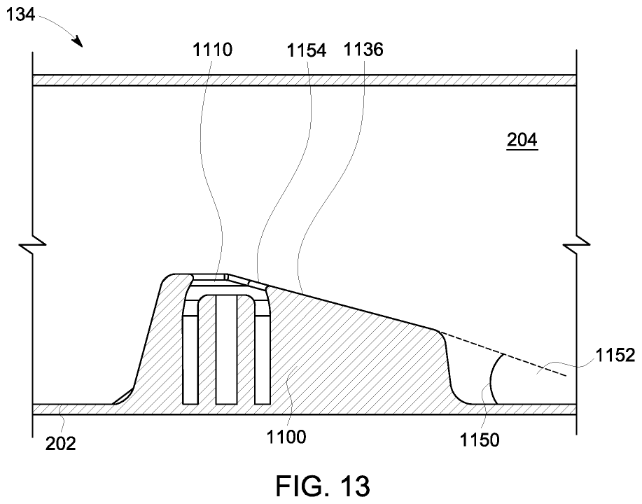

FIG. 13 is a schematic cutaway view of an exemplary micromixer 134 with a post 1100 circumscribing liquid fuel injection nozzle 210. Post 1100 is substantially similar to post 900 except that post 1100 includes an angled top surface 1136 and an angled opening 1110. In the exemplary embodiment, angled top surface 1136 and first wall 202 form an angle 1150. A dashed line 1152 is a continuation of angled top surface 1136. Angled top surface 1136 creates a back draft that reduces drag within micromixer 134. In the exemplary embodiment, angle 1150 is about 15 degrees. In alternative embodiments, angle 1150 is about 7 degrees to about 25 degrees. In alternative embodiments, angle 1150 includes any angle that enables turbine engine 100 to operate as described herein. In the exemplary embodiment, a portion 1154 of opening 1110 is angled with angled top surface 1136. Angled opening 1110 removes portion 1154 of angled opening 1110 such that the missing portion does not interfere with the injection of the liquid fuel into the compressed air stream.

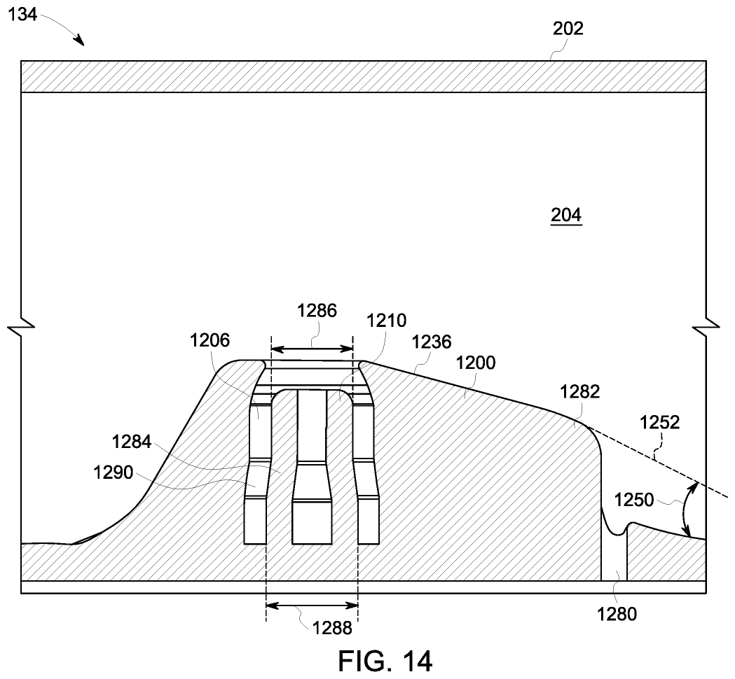

FIG. 14 is a schematic cutaway view of an exemplary micromixer 134 with a post 1200 circumscribing a liquid fuel injection nozzle 1210. Post 1200 is substantially similar to post 1100 except that post 1200 includes a trailing tube 1280 extending through first wall 202 and partially through post 1200. Trailing tube 1280 is configured to channel a flow of purge air into conduit 204 to blow fuel off of post 1200 and to ensure that no fuel is entraining in the wake of post 1200. Specifically, trailing tube 1280 is positioned on an aft end 1282 of post 1200 to blow fuel off of post 1200 downstream of liquid fuel injection nozzle 1210. In the exemplary embodiment, an angled top surface 1236 and first wall 202 form an angle 1250. A dashed line 1252 is a continuation of angled top surface 1236. Angled top surface 1236 creates a back draft that reduces drag within micromixer 134. In the exemplary embodiment, angle 1250 is about 15 degrees. In alternative embodiments, angle 1250 is about 0 degrees to about 25 degrees. In alternative embodiments, angle 1250 includes any angle that enables turbine engine 100 to operate as described herein. In the exemplary embodiment, liquid fuel injection nozzle 1210 includes a tube diameter reducer 1284 that reduces the diameter of liquid fuel injection nozzle 1210 from a first diameter 1286 to a second diameter 1288. Reducing the diameter of liquid fuel injection nozzle 1210 increases the exit velocity of the flow of liquid fuel from liquid fuel injection nozzle 1210 and decreases the pressure drop in liquid fuel injection nozzle 1210 while limiting the diameter at the exit of liquid fuel injection nozzle 1210. Additionally, post 1200 defines a chamber 1206 including a chamber diameter reducer 1290 corresponding to tube diameter reducer 1284 and circumscribing tube diameter reducer 1284.

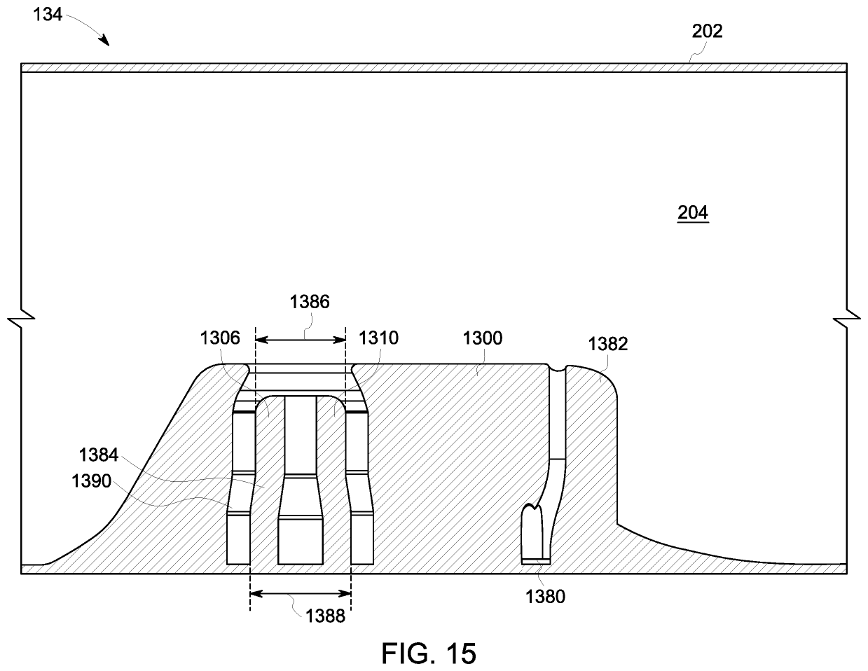

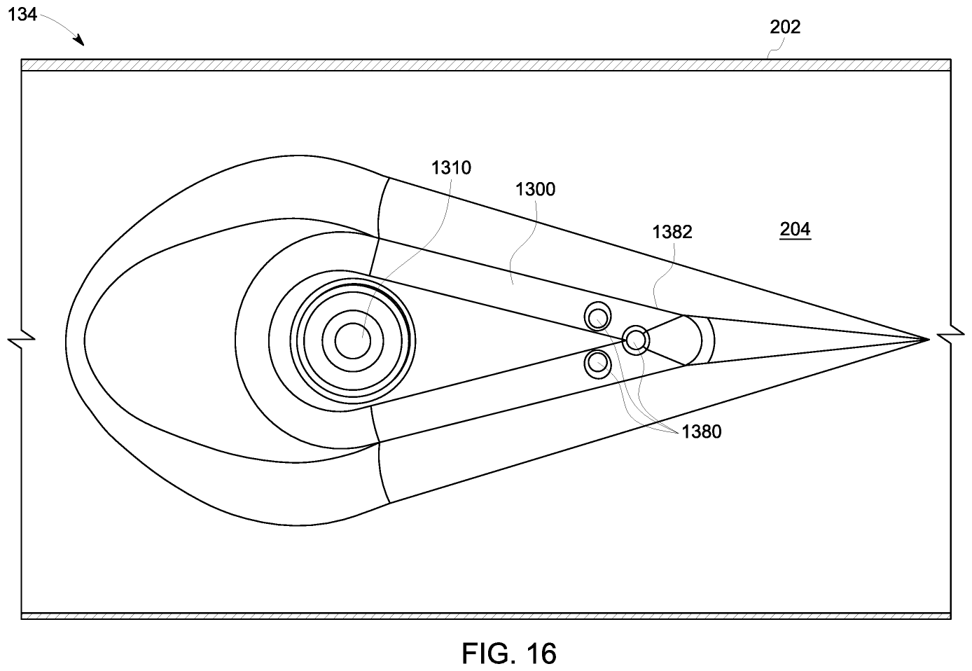

FIG. 15 is a schematic cutaway view of an exemplary micromixer 134 with a post 1300 circumscribing a liquid fuel injection nozzle 1310. FIG. 16 is a schematic cutaway view of an exemplary micromixer 134 showing a top view of post 1300 circumscribing liquid fuel injection nozzle 1310. Post 1300 is substantially similar to post 500 except that post 1300 includes a plurality of trailing tubes 1380 extending through first wall 202 and post 1300. Trailing tubes 1380 are configured to channel a flow of purge air into conduit 204 to blow fuel off of post 1300 and to ensure that no fuel is entraining in the wake of post 1300. Specifically, trailing tubes 1380 are positioned on an aft end 1382 of post 1300 to blow fuel off of post 1300 downstream of liquid fuel injection nozzle 1310. In the exemplary embodiment, liquid fuel injection nozzle 1310 includes a diameter reducer 1384 that reduces the diameter of liquid fuel injection nozzle 1310 from a first diameter 1386 to a second diameter 1388. Reducing the diameter of liquid fuel injection nozzle 1310 increases the exit velocity of the flow of liquid fuel from liquid fuel injection nozzle 1310 and decreases the pressure drop in liquid fuel injection nozzle 1310 while limiting the diameter at the exit of liquid fuel injection nozzle 1310. Additionally, post 1300 defines a chamber 1306 including a chamber diameter reducer 1390 corresponding to tube diameter reducer 1384 and circumscribing tube diameter reducer 1384.

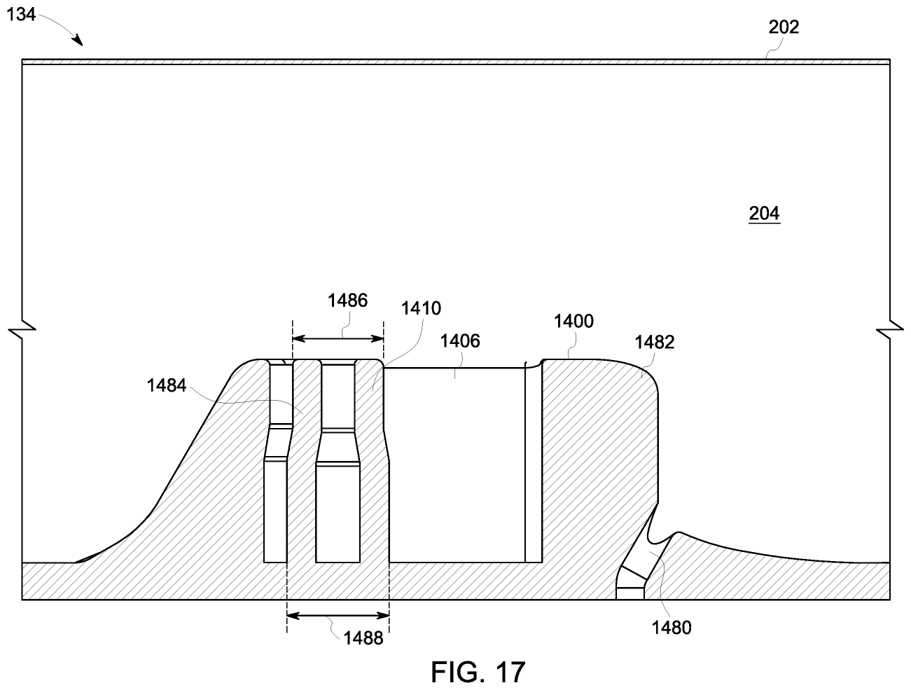

FIG. 17 is a schematic cutaway view of an exemplary micromixer 134 with a post 1400 circumscribing a liquid fuel injection nozzle 1410. Post 1400 is substantially similar to post 1300 except that post 1400 includes a single trailing tube 1480 extending through first wall 202 and partially through post 1400. Trailing tube 1480 is configured to channel a flow of purge air into conduit 204 to blow fuel off of post 1400 and to ensure that no fuel is entraining in the wake of post 1400. Specifically, trailing tube 1480 is positioned on an aft end 1482 of post 1400 to blow fuel off of post 1400 downstream of liquid fuel injection nozzle 1410. In the exemplary embodiment, liquid fuel injection nozzle 1410 includes a diameter reducer 1484 that reduces the diameter of liquid fuel injection nozzle 1410 from a first diameter 1486 to a second diameter 1488. Reducing the diameter of liquid fuel injection nozzle 1410 increases the exit velocity of the flow of liquid fuel from liquid fuel injection nozzle 1410 and decreases the pressure drop in liquid fuel injection nozzle 1410 while limiting the diameter at the exit of liquid fuel injection nozzle 1410. Additionally, post 1400 defines a large chamber 1406 that circumscribes liquid fuel injection nozzle 1410 and extends toward aft end 1482 of post 1400. The additional volume of large chamber 1406 creates a large purge area that reduces the wake in the flow of air and ensures that the flow of liquid fuel is not trapped in a boundary layer formed in conduit 204.

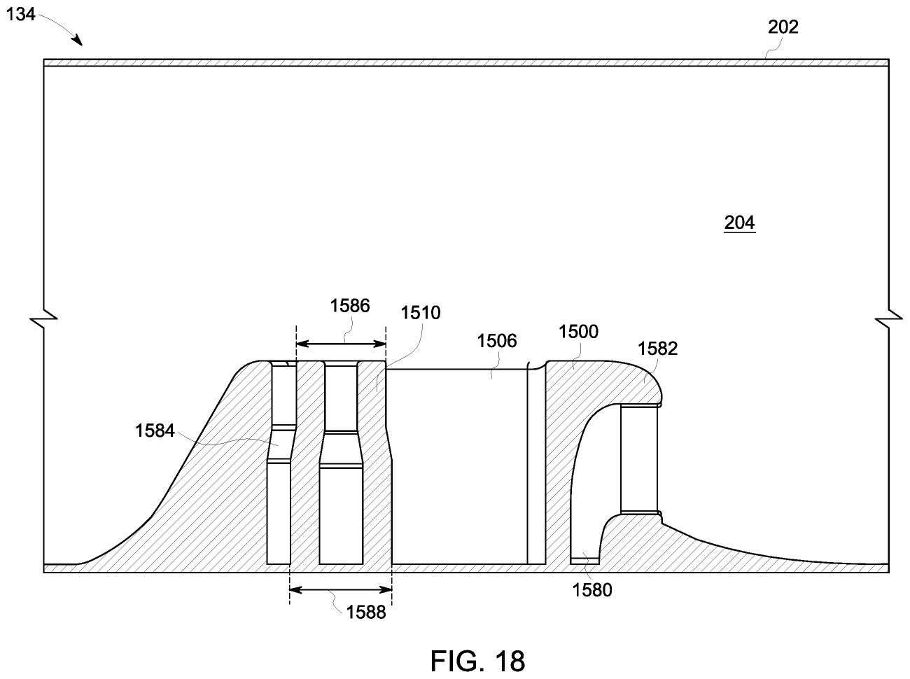

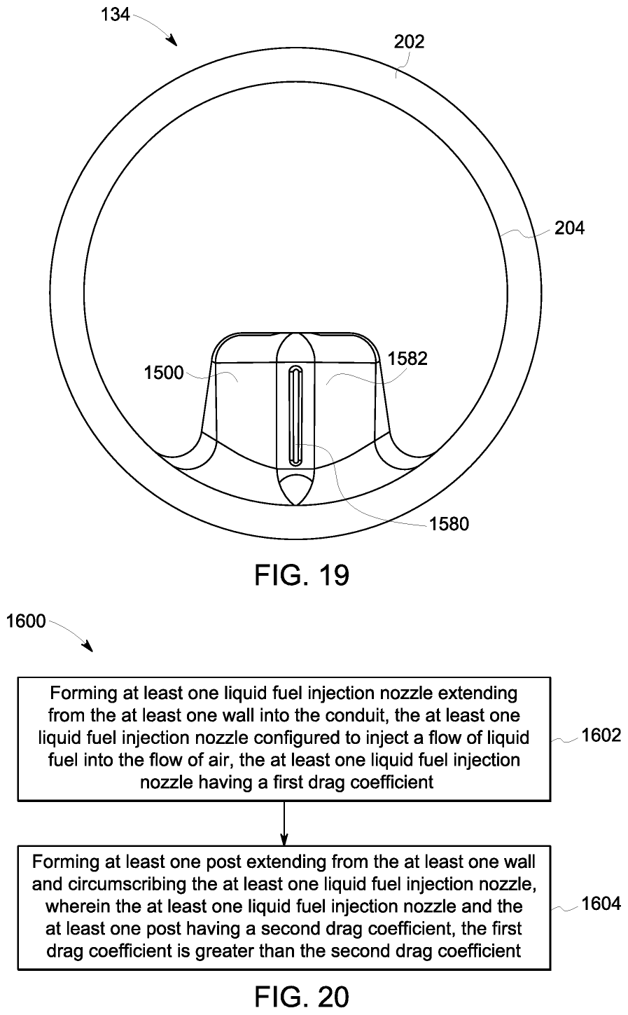

FIG. 18 is a schematic cutaway view of an exemplary micromixer 134 with a post 1500 circumscribing a liquid fuel injection nozzle 1510. FIG. 19 is a schematic cutaway view of an exemplary micromixer 134 showing a back view (looking opposite the direction of flow through micromixer 134) of post 1500 circumscribing liquid fuel injection nozzle 1510. Post 1500 is substantially similar to post 1400 except that post 1500 includes a trailing tube 1580 extending through first wall 202 and partially through an aft end 1582 of post 1500. Trailing tube 1580 is configured to channel a flow of purge air into conduit 204 to blow fuel off of post 1500 and to ensure that no fuel is entraining in the wake of post 1500. Specifically, trailing tube 1580 is positioned on aft end 1582 of post 1500 to blow fuel off of post 1500 downstream of liquid fuel injection nozzle 1510. In the exemplary embodiment, trailing tube 1580 is a vertical slit in aft end 1582 of post 1500. In the exemplary embodiment, liquid fuel injection nozzle 1510 includes a diameter reducer 1584 that reduces the diameter of liquid fuel injection nozzle 1510 from a first diameter 1586 to a second diameter 1588. Reducing the diameter of liquid fuel injection nozzle 1510 increases the exit velocity of the flow of liquid fuel from liquid fuel injection nozzle 1510 and decreases the pressure drop in liquid fuel injection nozzle 1510 while limiting the diameter at the exit of liquid fuel injection nozzle 1510. Additionally, post 1500 defines a large chamber 1506 that circumscribes liquid fuel injection nozzle 1510 and extends toward aft end 1582 of post 1500. The additional volume of large chamber 1506 creates a large purge area that reduces the wake in the flow of air and ensures that the flow of liquid fuel is not trapped in a boundary layer formed in conduit 204.

FIG. 20 is a flow diagram of a method 1600 of manufacturing a liquid fuel injection assembly for a gas turbine. The liquid fuel injection assembly includes micromixer 134 including at least one wall 202 defining conduit 204 configured to channel a flow of air. Method 1600 includes forming 1602 at least one liquid fuel injection nozzle 210 extending from at least one wall 202 into conduit 204. The at least one liquid fuel injection nozzle 210 is configured to inject a flow of liquid fuel into the flow of air. The at least one liquid fuel injection nozzle 210 has a first drag coefficient. Method 1600 also includes forming 1604 at least one post 400, 500, 900, 1000, 1100, 1200, 1300, 1400, and 1500 extending from at least one wall 202 and circumscribing the at least one liquid fuel injection nozzle 210. The at least one liquid fuel injection nozzle 210 and the at least one post 400, 500, 900, 1000, 1100, 1200, 1300, 1400, and 1500 have a second drag coefficient. The first drag coefficient is greater than the second drag coefficient. Additionally, the liquid fuel injection assembly manufactured by method 1600 may be manufactured by additive manufacturing. Specifically, liquid fuel injection nozzle 210 and at least one post 400, 500, 900, 1000, 1100, 1200, 1300, 1400, and 1500 may be manufactured by additive manufacturing.

The above-described liquid fuel injection nozzles and liquid fuel injection posts overcome a number of deficiencies of known liquid fuel injection systems for gas turbine engines and provide an effective method for injecting liquid fuel into a micromixer. Specifically, the liquid fuel injection nozzles described herein increase entrainment of liquid fuel into compressed air by injecting a flow of fuel into the center of a micromixer. Increasing the entrainment of fuel into compressed air reduces coking downstream of the liquid fuel injection nozzle, allows for an even and center-biased fuel distribution, and increases the efficiency of the gas turbine engine. Additionally, liquid fuel injection posts circumscribe the liquid fuel injection nozzles and increase the flow of compressed air towards the liquid fuel injection nozzles, further increasing the entrainment of fuel within the flow of compressed air. Additionally, the liquid fuel injection posts increase the efficiency of the gas turbine engine by reducing drag within the micromixer.

An exemplary technical effect of the methods and systems described herein includes: (a) injecting a flow of liquid fuel into a center of a micromixer; (b) reducing coking downstream of a liquid fuel injection nozzle; and (c) increasing efficiency of a gas turbine engine by reducing drag within a micromixer.

Exemplary embodiments of systems and methods for liquid fuel injection nozzles and liquid fuel injection posts are described above in detail. The methods and systems are not limited to the specific embodiments described herein, but rather, components of systems and/or steps of the methods may be utilized independently and separately from other components and/or steps described herein. For example, the method may also be used in combination with other injection systems, and are not limited to practice only with the gas turbine engines as described herein. Rather, the exemplary embodiments can be implemented and utilized in connection with many other applications.

Although specific features of various embodiments of the present disclosure may be shown in some drawings and not in others, this is for convenience only. In accordance with the principles of embodiments of the present disclosure, any feature of a drawing may be referenced and/or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A liquid fuel injection assembly for a gas turbine engine, said assembly comprising:
at least one micromixer comprising at least one wall defining a conduit configured to channel a flow of air;
at least one liquid fuel injection nozzle extending from said at least one wall into the conduit, said at least one liquid fuel injection nozzle configured to inject a flow of liquid fuel into the flow of air, said at least one liquid fuel injection nozzle having a first drag coefficient; and
at least one post extending from said at least one wall and circumscribing said at least one liquid fuel injection nozzle, said at least one liquid fuel injection nozzle and said at least one post having a second drag coefficient, wherein the first drag coefficient is greater than the second drag coefficient.

2. The liquid fuel injection assembly in accordance with claim 1, wherein said at least one post comprises a body defining an opening and a chamber therein, the chamber and said body circumscribing said at least one liquid fuel injection nozzle, said at least one liquid fuel injection nozzle configured to inject the flow of liquid fuel into the chamber, the opening configured to channel the flow of liquid fuel into the flow of air.

3. The liquid fuel injection assembly in accordance with claim 2, wherein said body has a cylindrical shape.

4. The liquid fuel injection assembly in accordance with claim 3, wherein said at least one liquid fuel injection nozzle has a first diameter and the chamber has a second diameter, and wherein the first diameter is less than the second diameter.

5. The liquid fuel injection assembly in accordance with claim 3, wherein said at least one liquid fuel injection nozzle extends from said at least one wall a first distance and said at least one post extends from said at least one wall a second distance, wherein the second distance is greater than the first distance.

6. The liquid fuel injection assembly in accordance with claim 2, wherein at least one liquid fuel injection nozzle includes a diameter reducer configured to accelerate the flow of liquid fuel into the flow of air.

7. The liquid fuel injection assembly in accordance with claim 2, wherein said body comprises a proximal portion and a distal portion.

8. The liquid fuel injection assembly in accordance with claim 7, wherein said proximal portion has a semi-cylindrical shape.

9. The liquid fuel injection assembly in accordance with claim 7, wherein said distal portion has a triangular prism shape.

10. The liquid fuel injection assembly in accordance with claim 7, wherein said distal portion comprises a top surface oriented substantially parallel to said at least one wall.

11. The liquid fuel injection assembly in accordance with claim 7, wherein said distal portion comprises a top surface, said top surface and said at least one wall defining an angle therebetween.

12. The liquid fuel injection assembly in accordance with claim 11, wherein the angle is about 60 degrees.

13. The liquid fuel injection assembly in accordance with claim 11, wherein the angle is less than 60 degrees.

14. The liquid fuel injection assembly in accordance with claim 11, wherein a portion of the opening is angled with said top surface.

15. A liquid fuel injection assembly for a gas turbine engine, the gas turbine engine including a compressor and a combustor, said liquid fuel injection assembly comprising:
at least one micromixer comprising at least one wall defining a conduit configured to channel a flow of air from the compressor to the combustor; and
at least one liquid fuel injection nozzle extending from said at least one wall into the conduit, wherein said at least one liquid fuel injection nozzle is configured to inject a flow of liquid fuel into the flow of air and the conduit is configured to channel the flow of air and the flow of liquid fuel into the combustor.

16. The liquid fuel injection assembly in accordance with claim 15, wherein said at least one liquid fuel injection nozzle and said at least one wall define an angle of about 90 degrees therebetween.

17. The liquid fuel injection assembly in accordance with claim 15, wherein said at least one liquid fuel injection nozzle and said at least one wall define an angle therebetween, wherein the angle is less than 90 degrees and greater than 30 degrees.

18. A method of manufacturing a liquid fuel injection assembly for a gas turbine, the liquid fuel injection assembly including a micromixer including at least one wall defining a conduit, the conduit configured to channel a flow of air, said method comprising:
forming at least one liquid fuel injection nozzle extending from the at least one wall into the conduit, the at least one liquid fuel injection nozzle configured to inject a flow of liquid fuel into the flow of air, the at least one liquid fuel injection nozzle having a first drag coefficient; and
forming at least one post extending from the at least one wall and circumscribing the at least one liquid fuel injection nozzle, wherein the at least one liquid fuel injection nozzle and the at least one post having a second drag coefficient, the first drag coefficient is greater than the second drag coefficient.

19. The method in accordance with claim 18, wherein forming the at least one liquid fuel injection nozzle comprises additively manufacturing the at least one liquid fuel injection nozzle within the conduit.

20. The method in accordance with claim 18, wherein forming at least one post comprises additively manufacturing the at least one post within the conduit.
